(19) United States
(12) Patent Application Publication
(10) Pub. No.: US 2015/0237311 A1
(43) Pub. Date: Aug. 20, 2015

(54) APPARATUS AND PROGRAM FOR GENERATING IMAGE TO BE DISPLAYED

(71) Applicant: DENSON CORPORATION, Kariya-city (JP)

(72) Inventors: YOSUKE HATTORI, Ama-gun (JP); MASAYOSHI OOISHI, Anjo-shi (JP); HIROAKI NIINO, Toyota-shi (JP); HIDESHI IZUHARA, Kasugai-shi (JP); HIROKI TOMABECHI, Ama-gun (JP)

(21) Appl. No.: 14/622,982

(22) Filed: Feb. 16, 2015

(30) Foreign Application Priority Data
Feb. 17, 2014 (JP) 2014-027639

(51) Int. Cl. H04N 7/18

(52) U.S. Cl. CPC H04N 7/183; B60R 2300/101

(57) ABSTRACT

In an apparatus, a first unit obtains a picked-up image in a travelling direction of a vehicle, and a second unit determines whether or not a driver of the vehicle is about to perform in parking of the vehicle or is performing parking of the vehicle. A third unit estimates, based on the obtained picked-up image, a target parking area of the vehicle when it is deter mined that the driver of the vehicle is about to perfoim parking of the vehicle or is perfoi ming parking of the vehicle. A fourth unit sets, based a position of the estimated target parking area relative to the vehicle, a display mode for the obtained picked-up image. A fifth unit generates, based on the picked-up image and the display mode for the picked-up image, an image to be displayed on the display device.

### CROSS REFERENCE TO RELATED APPLICATION

This application is based on and claims the benefit of priority from Japanese Patent Application No. 2014-027639,filed on Feb. 17, 2014,which is incorporated in its entirety herein by reference.

### TECHNICAL FIELD

The present disclosure relates to apparatuses and programs for generating, based on at least one picked-up image around the vehicle, images to be displayed.

### BACKGROUND

An example of these apparatuses is disclosed in Japanese Patent Application Publication No. 2010-215027, which will be referred to as a patent document. The apparatus disclosed in the patent document is installed in a vehicle. The apparatus is provided with four cameras. The four cameras are capable of respectively picking up images of four views, i.e. front views, left views, right views, and rear views, from the vehicle. The system switchably displays the picked-up images of the four views according the travelling conditions of the vehicle.

### SUMMARY

For the apparatus disclosed in the patent document, there is a requirement to display images each of which a driver of the vehicle wants to view while the driver is parking the vehicle with a more simplified structure as compared with the structure of the apparatus disclosed in the patent document.

In view the circumstances set forth above, one aspect of the present disclosure seeks to provide apparatuses and programs for generating, based on at least one picked-up image around a vehicle, an image to be displayed; each of the apparatuses and programs is capable of addressing the requirement set forth above.

Specifically, an alternative aspect of the present disclosure aims to provide such apparatuses and programs, each of which is capable of generating, based on at least one picked-up image around the vehicle, an image to be displayed, which a driver of the vehicle wants to view, with a more simplified structure as compared with the structure of the apparatus disclosed in the patent document.

According to a first exemplary aspect of the present disclosure, there is provided an apparatus for generating an image to be displayed on a display device. The apparatus includes a memory device, and a controller communicable to the memory device. The controller is configured to obtain at least one picked-up image in a travelling direction of a vehicle, and determine whether or not a driver of the vehicle is about to perform parking of the vehicle or is performing parking of the vehicle. The controller is configured to estimate, based on the obtained at least one picked-up image, a target parking area of the vehicle when it is determined that the driver of the vehicle is about to perform parking of the vehicle or is performing parking of the vehicle. The controller is configured to set, based a position of the estimated target parking area relative to the vehicle, a display mode for the obtained at least one picked-up image, the display mode representing how the at least one picked-up image is displayed on the display device. The controller is configured to generate, based on the at least one picked-up image and the display mode for the at least one picked-up image, an image to be displayed on the display device.

According to a second exemplary aspect of the present disclosure, there is provided a computer program product including a non-transitory computer-readable storage medium, and a set of computer program instructions embedded in the computer-readable storage medium, the instructions causing a computer to carry out:

(1) A first step of obtaining at least one picked-up image in a travelling direction of a vehicle

(2) A second step of deter mining whether or not a driver of the vehicle is about to perform parking of the vehicle or is perfoi ming parking of the vehicle

(3) A third step of estimating, based on the obtained at least one picked-up image, a target parking area of the vehicle when it is determined that the driver of the vehicle is about to perform parking of the vehicle or is performing parking of the vehicle

(4) A fourth step of setting, based a position of the estimated target parking area relative to the, vehicle, a display mode for the obtained at least one picked-up image, the display mode representing how the at least one picked-up image is displayed on the display device

(5) A fifth step of generating, based on the at least one picked-up image and the display mode for the at least one picked-up image, an image to be displayed on the display device.

Each of the apparatus and computer program product according to the first and second exemplary aspects of the present disclosure makes it possible to change the display mode for the obtained at least one picked-up image depending on change in the relative position of the estimated target parking area.

This makes it possible to generate an image to be displayed on the display device such that a driver of the vehicle can easily view the target parking area from the image displayed on the display device. That is, each of the apparatus and program product generates at least one image, which the driver of the vehicle wants to view during parking of the vehicle, to be displayed on the display device without switchably displaying images picked up by plural-view cameras. This results in the driver of the vehicle easily parking the vehicle in the target parking area with the more simplified structure of the apparatus as compared with the structure of the system disclosed in the patent document.

The above and/or other features, and/or advantages of various aspects of the present disclosure will be further appreciated in view of the following description in conjunction with the accompanying drawings. Various aspects of the present disclosure can include and/or exclude different features, and/or advantages where applicable. In addition, various aspects of the present disclosure can combine one or more feature of other embodiments where applicable. The descriptions of features, and/or advantages of particular embodiments should not be construed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the overall structure of an image display system installed in a vehicle according to an embodiment of the present disclosure;

FIG. 2 is a flowchart schematically illustrating a display control routine carried out by a controller of the image display system illustrated in FIG. 1;

FIG. 3 is a flowchart schematically illustrating a subroutine called by the display control routine;

FIG. 4A is a view schematically illustrating a display region of picked-up images for a display device illustrated in FIG. 1;

FIG. 4B is a view schematically illustrating a plurality of parking-area candidates, and is used for describing an operation in step S240 of FIG. 2;

FIG. 5A is a graph schematically illustrating a relationship between the speed of the vehicle and the display region according to this embodiment;

FIG. 5B is a graph schematically illustrating a relationship between the distance of a target parking area relative to the vehicle and the display region according to this embodiment;

FIG. 6A is a view schematically illustrating the display region of picked-up images for the display device when the display region is set to a backward wide region according to this embodiment;

FIG. 6B is a view schematically illustrating a dip angle of the imaging region, i.e. the display region;

FIG. 6C is a view schematically illustrating the display region of picked-up images for the display device when the display region is set a backward lower region according to this embodiment;

FIG. 7A is a view schematically illustrating an example of backward wide images being displayed on the display device according to this embodiment; and

FIG. 7B is a view schematically illustrating an example of backward lower images being displayed on the display device according to this embodiment.

### DETAILED DESCRIPTION OF EMBODIMENT

A specific embodiment of the present disclosure will be described hereinafter with reference to the accompanying drawings.

An image display system 1, to which an apparatus according to the specific embodiment is applied, is installed in a vehicle, such as a passenger vehicle, V. The image display system 1 has functions of successively generating, based on picked-up images around the vehicle V, images to be displayed, and successively displaying the images on a display device 26. Particularly, the image display system 1 according to this embodiment is specially configured to display more visible at least one image of a region contained in a visual field of the vehicle V; the region is at least part of the visual field, which a driver of the vehicle V wants to visibly recognize while the vehicle V is going backward.

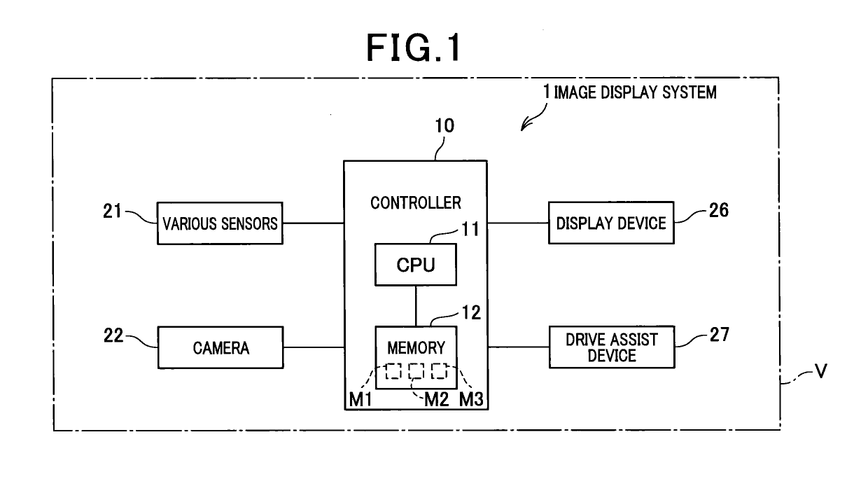

Referring to FIG. 1, the image display system 1 includes a controller 10, various sensors 21, a camera 22, the display device 26, and a drive assist device 27.

The various sensors 21 include, for example, first type of sensors for measuring the travelling conditions of the vehicle V, such as a vehicle speed sensor, a shift position sensor, a steering-angle sensor, a brake sensor, and an accelerator position sensor. The various sensors 21 also include, for example second type of sensors for monitoring the travelling environments around the vehicle V.

The vehicle speed sensor is operative to measure the speed of the vehicle V, and operative to output, to the controller 10, a vehicle-speed signal indicative of the measured speed of the vehicle V.

The shift position sensor is operative to detect a driver's selected position of a transmission installed in the vehicle V, and output a shift signal indicative of the driver's selected position to the controller 10. For example, the positions of the transmission selectable by a driver represent a plurality of gear positions including, for example, forward gear positions of the vehicle V, a reverse position for reverse drive of the vehicle V, a neutral position.

The steering-angle sensor is operative to output, to the controller 10, a signal indicative of a driver's operated steering angle of a steering wheel of the vehicle V.

The brake sensor is operative to, for example, detect a driver's operated quantity of a brake pedal of the vehicle V, and output, to the controller 10, a brake signal indicative of the driver's operated quantity of the brake pedal.

The accelerator position sensor is operative to detect a position of a throttle valve for controlling the amount of air entering an internal combustion engine of the vehicle V. That is, the position of the throttle valve represents how the throttle valve is opened. The accelerator position sensor is operative to output an accelerator-position signal indicative of the detected position of the throttle valve as an accelerator position to the controller 10.

That is, the signals sent from the first type of sensors including the vehicle speed sensor, shift position sensor, steering-angle sensor, brake sensor, and accelerator position sensor are received by the controller 10 as travelling-condition signals.

The second type of sensors are operative to monitor the travelling environments around the vehicle V; the travelling environments include whether there is at least one obstacle around the vehicle V, and how roads or areas on which the vehicle V is going to run are. The second type of sensors are operative to output, to the controller 10, travelling-environment signals indicative of the monitored travelling environments around the vehicle V.

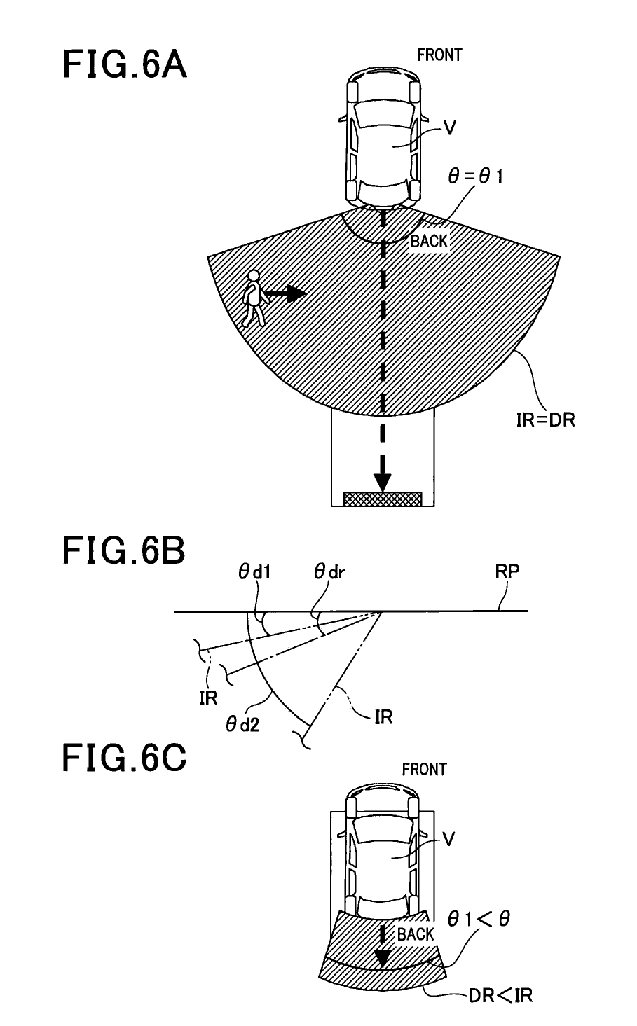

The camera 22 is attached to, for example, the rear center of the vehicle V. The camera 22 is designed as a known backup camera or rear view camera, which has, as its imaging region IR, i.e. imaging range, a relatively wide sector region in a horizontal direction, i.e. the width direction of the vehicle V toward the rear of the vehicle V (see, for example, FIG. 6A). Specifically, the sector imaging region IR has a symmetric shape relative to the optical axis of the camera 22, extends toward the rear side of the vehicle V, and has a predetermined view angle θ, which is a center angle θ, in the vehicle width direction. The imaging region IR has a predetermined vertical width in the height direction of the vehicle V.

In addition, the imaging region IR has a changeable dip angle θd relative to a reference horizontal plane RP that includes the optical axis of the camera 22 and is parallel to a road surface on which the vehicle V is running (see FIG. 6B).

Specifically, the camera 22 is operative to successively pick up images of the imaging region IR, and successively send the picked-up images as digital images, i.e. digital image data, to the controller 10. In this embodiment, the single camera 22 is used, but a plurality of cameras 22 can be used.

The display device 26 is operative to successively display images generated by the controller 10. A commercially available display for vehicles can be used as the display device 26.

In this embodiment, a display region, i.e. display range, DR for the display device 26 is controllably determined within the imaging region IR by the controller 10. That is, the display region DR represents at least a part of an image picked-up by the camera 22 based on the imaging region IR, which is contained in the display region DR, should be displayed on the display device 26. In other words, the other part of the picked-up image, which is not contained in the display region DR, should not be displayed on the display device 26.

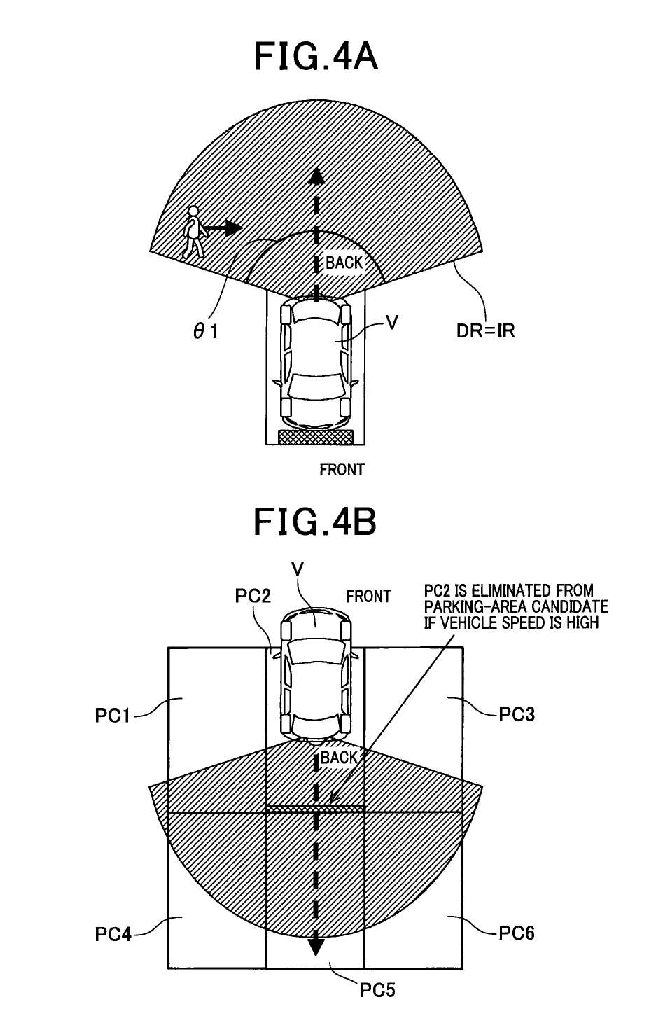

For example, as illustrated in FIG. 4A, the display region DR has a symmetric sector shape relative to the optical axis of the camera 22, extends toward the rear side of the vehicle V, and has a changeable view angle θ1, which is a center angle θ1, in the vehicle width direction. That is the view angle θ1 of the display region DR is changeable within the range from zero to view angle θ of the imaging region IR inclusive.

The drive assist device 27 is operative to perform, under control of the controller 10, a task for assisting parking of the vehicle V; the task includes controlling, i.e. assisting, the accelerator position of the vehicle V, the quantity of the brake pedal of the vehicle V, and the steering angle of the steering wheel of the vehicle V.

The controller 10 is mainly comprised of a well-known microcomputer consisting of, for example, a CPU 11 and a memory unit 12 including at least one of a ROM and a RAM, which are communicably connected to each other. Particularly, the memory unit 12 includes a non-volatile memory that does not need power to retain data.

The CPU 11 performs various routines, i.e. various sets of instructions, including a display control routine, stored in the memory 12.

Next, operations of the image display system 1 according to this embodiment will be described hereinafter.

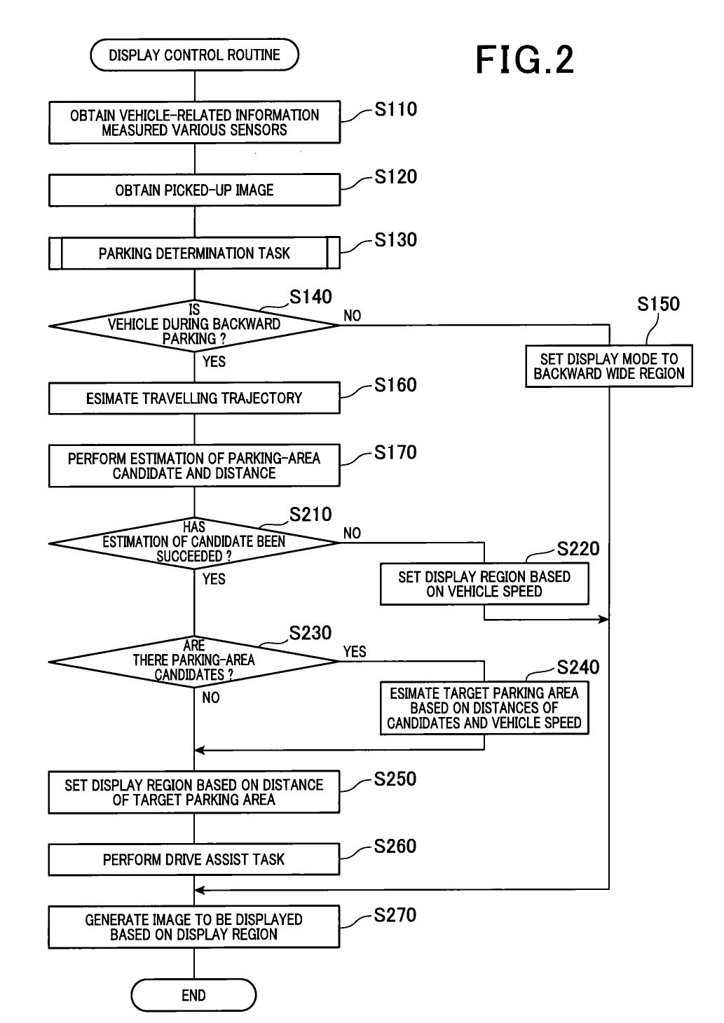

For example, when the vehicle V is powered on, i.e. the ignition of the vehicle V is switched on, the CPU 11 of the controller 10 starts the display control routine, and performs the display control routine every predetermined cycle (see FIG. 2).

When starting the display control routine, the CPU 11 receives, as vehicle-related information, the signals sent from the various sensors 21 in step S110, and receives one of the digital images successively picked up by the camera 22 in step S120. The signals sent from the various sensors 21 show measurement results thereof.

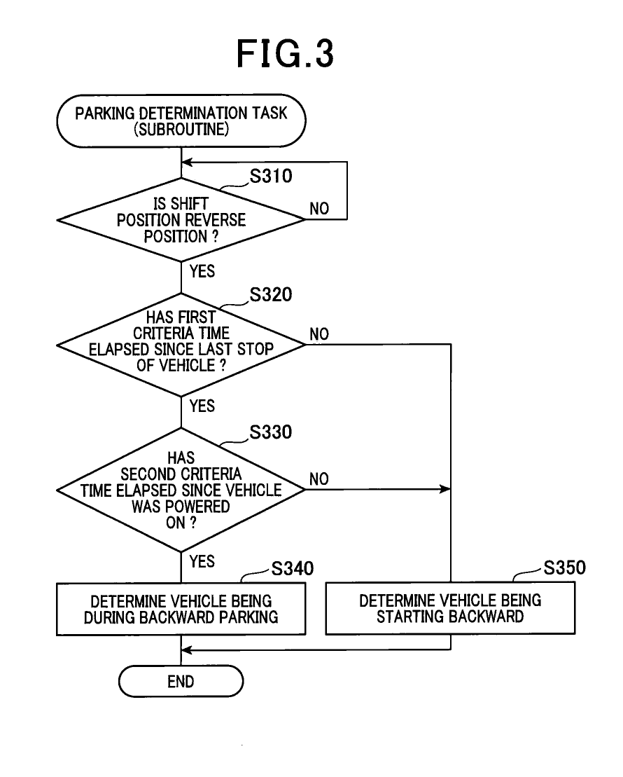

Next, the CPU 11 calls a subroutine for performing a parking determination task in step S130; the parking determination task is designed to determine whether the vehicle V is going to be parking or starting. An example of the execution procedure of the subroutine will be described as a subroutine in FIG. 3.

When calling the subroutine, the CPU 11 determines whether the driver's selected position of the transmission is shifted to the reverse position from another position based on the signal sent from the shift position sensor in step S310.

When it is determined that the driver's selected position of the transmission is not shifted to the reverse position from another position (NO in step S310), the CPU 11 repeats the determination in step S310.

Otherwise, when it is determined that the driver's selected position of the transmission is shifted to the reverse position from another position (YES in step S310), the CPU 11 determines whether a predetermined first criteria time has elapsed since the vehicle V was stopped at the last time in step S320.

Note that the CPU 11 of the controller 10 is designed to write the time at which the vehicle V was last stopped before the current cycle of execution of the display control task, into the non-volatile memory of the memory unit 12 as a last vehicle-stop time. That is, the CPU 11 updates the last vehicle-stop time previously stored in the non-volatile memory of the memory unit 12 to a current one each time the vehicle V is stopped.

Specifically, in step S320, the CPU 11 can compare the last vehicle-stop time stored in the non-volatile memory of the memory unit 12 with current time, thus calculating actual elapsed time since the last vehicle-stop time. Then, in step S320, the CPU 11 can determine whether the actual elapsed time is equal to or larger than the first criteria time.

Note that the first criteria time represents an example of plural time lengths for determining whether the driver of the vehicle V is going to perform parking of the vehicle V. For example, the first criteria time is set to a relatively short time length, such as ten minutes or therearound.

When the driver's shift operation to the reverse position from another position is carried out after a long period of time has elapsed since the vehicle V was last stopped, there is a high possibility that the vehicle V is currently parked. This results in the probability of parking the vehicle V after lapse of the long period of time becoming a lower value.

When it is determined that the first criteria time has elapsed since the vehicle V was last stopped (YES in step S320), the subroutine proceeds to step S350 described later. Otherwise, when it is determined that the first criteria time has not elapsed yet since the vehicle V was last stopped (NO in step S320), the CPU 11 determines whether a predetermined second criteria time has elapsed since the vehicle V was powered on (i.e. power supply to the vehicle V was started) in step S330.

Note that the CPU 11 of the controller 10 is designed to hold, as elapsed time, time that has elapsed since the vehicle V was powered on so that the controller 10 was activated.

Specifically, in step S330, the CPU 11 can compare the elapsed time with the second criteria time, and can deter mine whether the elapsed time is equal to or greater than the second criteria time based on the results of the comparison.

Note that the second criteria time represents an example of plural time lengths for determining whether the driver of the vehicle V is going to perform parking of the vehicle V. For example, the second criteria time is set to a relatively short time length, such as five minutes or therearound.

When the driver's shift operation to the reverse position from another position is carried out before five minutes or therearound has elapsed since the vehicle V was powered on, there is a high possibility that the driver of the vehicle V is not performing parking of the vehicle V, but is performing a starting operation of the vehicle V backward.

When it is determined that the second criteria time has elapsed since the vehicle V was powered on (YES in step S330), the CPU 11 determines that a driver of the vehicle V is trying to move or is moving the vehicle V backward to park the vehicle V, i.e. the driver is trying to perform or is performing backward parking of the vehicle V in step S340. That is, backward parking means that the vehicle V is currently being parked backward.

Then, in step S340, the CPU 11 stores an operating parameter of the vehicle V in the memory unit 12; the parameter has information representing that the driver of the vehicle V is about to perform the backward parking of the vehicle V or is performing the backward parking of the vehicle V. In other words, the parameter has information representing that the vehicle V is about to be parked backward or currently being parked backward.

After the operation in step S340, the CPU 11 terminates the subroutine, and carries out the next operation in the display control routine illustrated in FIG. 2.

Otherwise, when it is determined that the second criteria time has not elapsed yet since the vehicle V was powered on (NO in step S330), the CPU 11 determines that the vehicle V is trying to start backward or is starting backward in step S350. Then, in step S350, the CPU 11 stores the operating parameter of the vehicle V in the memory unit 12; the operating parameter has information representing that the vehicle V is trying to start backward or is starting backward. After completion of the operation in step S35, the CPU 11 terminates the subroutine, and carries out the next operation in step S140 of the display control routine illustrated in FIG. 2.

Specifically, in step S140, the CPU 11 reads the operating parameter of the vehicle V from the memory unit 12, and determines, based on the information shown by the operating parameter of the vehicle V, whether or not the driver of the vehicle V is about to perform the backward parking of the vehicle V or is perfoi ming the backward parking of the vehicle V.

When it is determined that the driver of the vehicle V is neither about to perform the backward parking of the vehicle V nor performing the backward parking of the vehicle V (NO in step S140), the CPU 11 recognizes that the vehicle V is trying to start backward or is starting backward. Then, the CPU 11 sets, i.e. changes, the display region (display range) DR for the display device 26 to be wider than a reference sector region in step S150.

For example, the CPU 11 sets the view angle θ1 of the display region DR to be identical to the view angle θ of the imaging region IR, thus setting the display region DR for the display device 26 to be identical to the imaging region IR of the camera 22 in step S150 (see FIG. 4A).

In step S150, the CPU 11 also sets the dip angle θd of the imaging region IR, i.e. the display region DR, relative to the reference horizontal plane RP to be smaller than a reference dip angle θdr (see FIG. 6B). After the operation in step S150, the display control routine proceeds to step S270.

Otherwise, when it is determined that the driver of the vehicle V is about to perform the backward parking of the vehicle V or is performing the backward parking of the vehicle V (YES in step S140), the CPU 11 predicts a travelling trajectory of the vehicle V based on the signal indicative of the vehicle speed sent from the vehicle speed sensor, and the signal indicative of the steering angle sent from the steering angle sensor in step S160. Specifically, the travelling trajectory of the vehicle V represents a future trajectory along which the vehicle V is going to travel.

Next, the CPU 11 performs a parking-area candidate extracting operation in step S170.

Specifically, the CPU 11 tries to estimate, based on a currently picked-up image (digital image) input to the controller 10, at least one parking-area candidate located close to the predicted travelling trajectory using one of known marker recognition technologies in step S170. The at least one parking-area candidate is, for example, at least one rectangular-like area partitioned by painted markers; the at least one area has a size enough to permit the vehicle V to be parked therein.

In step S170, if the CPU 11 has succeeded in estimating at least one parking-area candidate, the CPU 11 estimates, based on a currently picked-up image, a minimum distance between, for example, the center or the camera position of the rear head of the vehicle V and, for example, a point of the at least one parking-area candidate. The point is, for example, located on one lateral side of the at least one parking-area candidate; the one lateral side is opposite to the other lateral side of the at least one parking-area candidate through which the vehicle V is going to enter.

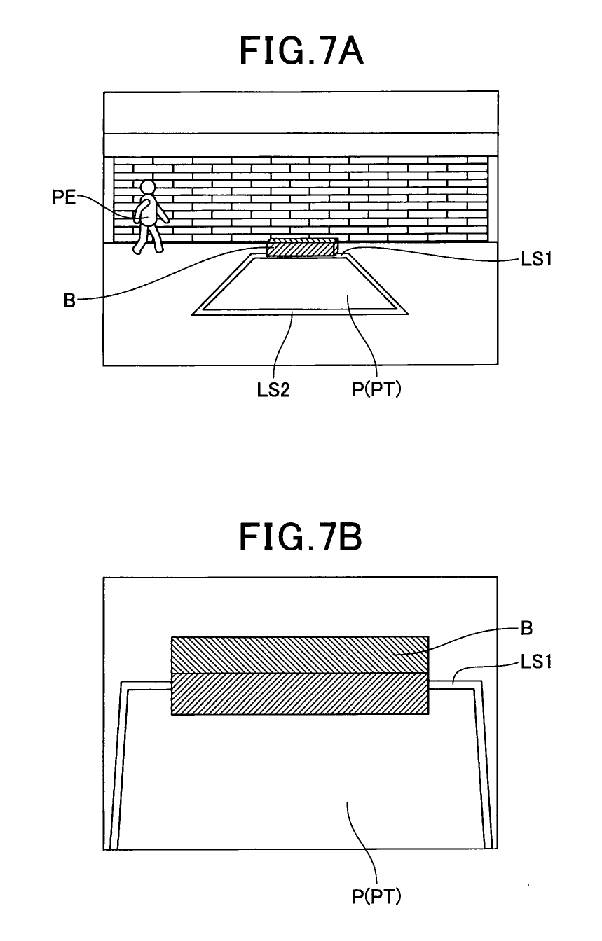

For example, in FIG. 7A, reference character P represents at least one parking-area candidate, LS1 represents a first lateral side of the at least one parking-area candidate P, and reference character LS2 represents a second lateral side thereof opposite to the first lateral side LS1. The minimum distance between the center or the camera position of the rear head of the vehicle V and the point of the at least one parking-area candidate will be referred to as a distance of the at least one-area candidate with respect to the vehicle V.

Next, the CPU 11 determines whether the CPU 11 has succeeded in estimating, i.e. detecting, at least one parking-area candidate in step S210.

When it is determined that the CPU 11 has not succeeded in estimating at least one parking-area candidate (NO in step S210), the CPU 11 sets, i.e. changes, the display region DR based on at least one of the travelling-condition signals and the travelling environment signals sent from the vehicle speed sensor in step S220. For example, the CPU 11 adjusts the display region DR depending on the speed of the vehicle V in step S220.

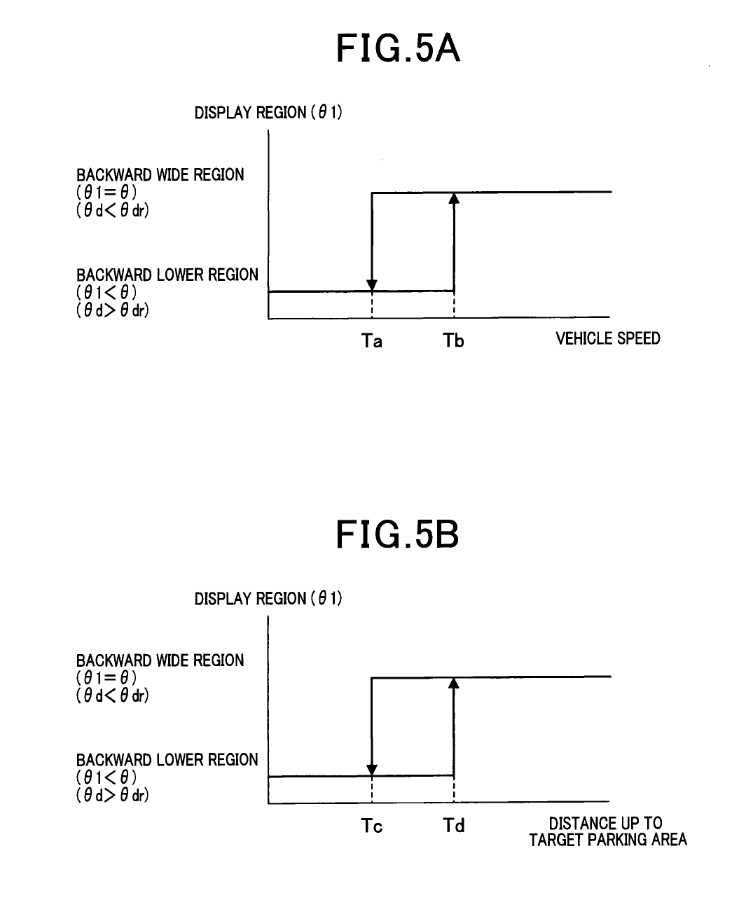

For example, the controller 10 according to the first embodiment has a map M1 in data-table or mathematical expression fog mat stored in the memory unit 12 (see FIG. 1), and/or a program format coded in the display control routine. The map M1 includes infoi illation indicative of a relationship between values of the speed of the vehicle V, values of the view angle θ of the display region DR, and values of the dip angle θd of the imaging region IR (display region DR) as illustrated in for example FIG. 5A.

Specifically, the CPU 11 extracts a value of the view angle θof the display region DR and a value of the dip angle θd of the imaging region IR from the map M1; the value of the view angle θ of the display region DR and the value of the dip angle θd of the imaging region IR correspond to a current value of the speed of the vehicle V.

For example, when the current value of the speed of the vehicle V is equal to or higher than a first threshold speed Tb, the CPU 11

1. Sets the display region DR to be wider than the reference sector region

2. Sets the dip angle 0d of the imaging region IR to be smaller than the reference dip angle Odr in step S220 (see FIG. 6B).

In this case, the CPU 11 specifically sets the view angle θ1 of the display region DR to be identical to the view angle θ of the imaging region IR, thus setting the display region DR for the display device 26 to be identical to the imaging region IR of the camera 22 in step S220 (see FIG. 6A). When the display region DR is set to be identical to the imaging region IR, the display region DR will be referred to as a backward wide region hereinafter. This results in the whole of an image currently picked up by the camera 22 based on the imaging region IR being displayed based on the display region DR on the display device 26 as a backward wide image (see step 5270 described later).

In other words, changing, i.e. setting, the display region DR controls a display mode for an image, which is currently picked-up by the camera 22 based on the imaging region IR; the display mode for an image represents how the image is displayed on the display device 26. For example, the display region DR being set to the backward wide region sets the display mode for a currently picked-up image based on the imaging region IR to a first display mode in which the whole of the currently picked-up image based on the imaging region IR is displayed on the display device 26.

For example, an example of backward wide images displayed on the display device 26 when the display region DR is set to the backward wide region is illustrated in FIG. 7A. Specifically, an example of the backward wide images illustrated in FIG. 7A shows a backward wide area around the rear end of the vehicle V in the same manner as the driver of the vehicle V views a backward scene from the position at which the camera 22 is located. The display region DR being set to the backward wide region permits the driver V to view, based on a displayed image, i.e. a backward wide image, at least one parking-area candidate P, and pedestrians PE and other vehicles located at the backward of the vehicle V.

In contrast, when the current value of the speed of the vehicle V is lower than a second threshold speed Ta, the CPU 11

1. Sets the display region DR to be narrower than the reference sector region

2. Sets the dip angle θd of the imaging region IR to be larger than the reference dip angle θdr in step S220 (see FIGS. 6B and 6C).

In this case, the CPU 11 preferably manipulates a part of a currently picked-up image contained in the display region DR smaller than the imaging region IR to thereby enlarge the part of the currently picked-up image. When the display region DR is set to be narrower than the reference sector region, and sets the dip angle θd of the imaging region IR to be larger than the reference dip angle θdr, the display region DR will be referred to as a backward lower region hereinafter. As a result, a part of an image currently picked up by the camera 22, which is included in the backward lower region DR, is displayed as an image on the display device 26 while being enlarged as a backward lower image (see step S270 described later).

For example, the display region DR being set to the backward lower region sets the display mode for a currently picked-up image based on the imaging region IR to a second display mode in which a part of the currently picked-up image based on the imaging region IR, which is included in the display region DR, is displayed on the display device 26. In addition, the display region DR being set to the reference sector region while the dip angle θd of the imaging region IR is set to the reference dip angle θdr sets the display mode for a currently picked-up image based on the imaging region IR to a third display mode.

For example, an example of backward lower images displayed on the display device 26 when the display region DR is set to the backward lower region is illustrated in FIG. 7B. Specifically, an example of the backward lower images illustrated in FIG. 7B shows an enlarged view of the lower region around the rear end of the vehicle V. The display region DR being set to the backward lower region makes it possible for the driver to easily recognize the distance from the rear end of the vehicle V up to a vehicle-stop block B located on or close to the first lateral side LS1 of at least one parking-area candidate, or up to a wall surface of a car park located close to the first lateral side LS1.

On the other hand, when the current value of the speed of the vehicle V is equal to or higher than the second threshold speed Ta and lower than the first threshold speed Tb, the CPU 11 keeps the display region DR unchanged. This displays, on the display device 26, a part of a currently picked-up image, which is contained in the unchanged display region DR in steps S220 and S270. Specifically, if the display region DR is set as the backward lower region, the CPU 11 displays a currently picked-up image as the backward wide image on the display device 26 in steps S220 and S270.

Let us assume the various sensors 21 include an acceleration sensor for measuring an acceleration of the vehicle V and outputting, to the controller 10, an acceleration signal indicative of the measured acceleration of the vehicle V. In this assumption, the CPU 11 can set, i.e. change, the display region DR, i.e. the view angle θ1 of the display region DR and the dip angle θd of the imaging region IR, depending on the acceleration of the vehicle V based on the signal sent from the acceleration sensor in step S220.

After the operation in step S220, the display control routine proceeds to step S270 described later.

On the other hand, when it is determined that the CPU 11 has succeeded in estimating at least one parking-area candidate (YES in step S210), the CPU 11 determines whether there are two or more parking-area candidates estimated in step S170 in step S230.

When it is determined that there is at least one parking-area candidate estimated in step S170 (NO in step S230), the CPU 11 determines that the at least one parking-area candidate as a target parking area PT for the vehicle V in step S230. Thereafter, the display control routine proceeds to step S250.

Otherwise, when it is determined that there are two or more parking-area candidates estimated in step S170 (YES in step S230), the display control routine proceeds to step S240.

In step S240, the CPU 11 estimates one of the two or more parking-area candidates as a target parking area PT for the vehicle V according to at least one of the travelling-condition signals and the travelling-environment signals sent from the various sensors 21. For example, in step S240, the CPU 11 estimates one of the two or more parking-area candidates as the target parking area PT for the vehicle V according to the speed of the vehicle V, and the distances of the respective two or more parking-area candidates estimated in step S170.

For example, the controller 10 according to the first embodiment has a map M2 in data-table or mathematical expression format stored in the memory unit 12 (see FIG. 1), and/or a program format coded in the display control routine. The map M2 includes information indicative of a relationship between values of the speed of the vehicle V and values of the lower limit for the distances of parking area candidates selectable as a parking area. For example, the relationship shows that, the higher the speed of the vehicle V is, the longer the lower limit for the distances of parking-area candidates selectable as a parking area.

Specifically, as illustrated in FIG. 4B, in step S240, the CPU 11 extracts values of the lower limit for the two or more parking-area candidates (PC1 to PC6 in FIG. 4B); the values of the lower limit correspond to a current value of the speed of the vehicle V. If the distance of the parking-area candidate PC2 estimated in step S170 is shorter than the value of the lower limit corresponding to the parking-area candidate PC2 (see FIG. 4B), the CPU 11 eliminates the parking-area candidate PC2 from the six parking-area candidates PC1 to PC6.

Then, in step S240, the CPU 11 selects one of the remaining parking-area candidates as the target parking area PT for the vehicle V; the distance of one of the remaining parking-area candidates is the shortest in the distances of the remaining parking-area candidates.

The CPU 11 can perform the operations in step S240 set forth above using the acceleration of the vehicle V based on the signal sent from the acceleration sensor in place of the speed of the vehicle V if the various sensors 21 include the acceleration sensor.

After the operations in step S240, the display control routine proceeds to step S250.

In step S250, the CPU 11 sets, i.e. changes, the display region DR according to at least one of the travelling-condition signals and the travelling environment signals sent from the vehicle speed sensor in step S250. For example, the CPU 11 adjusts the display region DR according to the distance of the target parking area PT relative to the vehicle V such that at least part of the target parking region PT is included in the display region DR in step S250.

For example, the controller 10 according to the first embodiment has a map M3 in data-table or mathematical expression format stored in the memory unit 12 (see FIG. 1), and/or a program format coded in the display control routine. The map M3 includes information indicative of a relationship between values of the distance of target parking areas, values of the view angle θ of the display region DR, and values of the dip angle θd of the imaging region IR (display region DR) as illustrated in for example FIG. 5B.

Specifically, the CPU 11 extracts a value of the view angle θ of the display region DR and a value of the dip angle θd of the imaging region IR from the map M3; the value of the view angle θ of the display region DR and the value of the dip angle θd of the imaging region IR correspond to a value of the distance of the target parking area PT.

For example, when the value of the distance of the target parking area PT is equal to or greater than a first threshold distance Td, the CPU 11 sets the display region DR to be wider than the reference sector region, and sets the dip angle θd of the imaging region IR to be smaller than the reference dip angle θdr in step S250 (see FIG. 6B). In this case, the CPU 11 specifically sets the view angle θ1 of the display region DR to be identical to the view angle θ of the imaging region IR, thus setting the display region DR as the backward wide region set forth above in step S250 (see FIG. 7A).

This results in an example of backward wide images being displayed on the display device 26 as illustrated in FIG. 7A (see step S270 described later). An example of the backward wide images illustrated in FIG. 7A shows a backward wide area around the rear end of the vehicle V including the whole shape of the target parking area PT and pedestrians PE existing around the determined or selected parking area.

In contrast, when the value of the distance of the target parking area PT is smaller than a second threshold distance Tc, the CPU 11 changes the display region DR to be narrower than the reference sector region, and changes the dip angle θd of the imaging region IR to be larger than the reference dip angle θdr in step S250 (see FIGS. 6B and 7B), thus setting the display region DR as the backward lower region set forth above.

This results in an example of backward lower images being displayed on the display device 26 as illustrated in FIG. 7B (see step S270 described later). An example of the backward lower images illustrated in FIG. 7B shows an enlarged view of the lower region around the rear end of the vehicle V. The display region DR being set to the backward lower region makes it possible for the driver to easily recognize the distance from the rear end of the vehicle V up to a vehicle-stop block B located on or close to the first lateral side LS1 of the target parking area PT, or up to a wall surface of a car park located close to the first lateral side LS1.

On the other hand, when the value of the distance of the target parking area PT is equal to or higher than the second threshold distance Tc and lower than the first threshold distance Td, the CPU 11 keeps the display region DR unchanged. This displays, on the display device 26, a part of a currently picked-up image, which is contained in the display region DR in steps S250 and S270. Specifically, in the display region DR is set as the backward lower region, the CPU 11 displays a currently picked-up image as the backward wide image on the display device 26 in steps S250 and S270.

After execution of the operation in step S250 is completed, the CPU 11 performs a drive assist task, i.e. a parking assist task, using the drive assist device 27 in step S260. Specifically, the CPU 11 instructs the drive assist device 27 to perform a task for assisting parking of the vehicle V in the target parking area PT; the task includes controlling, i.e. assisting, the accelerator position of the vehicle V, the quantity of the brake pedal of the vehicle V, and the steering angle of the steering wheel of the vehicle V.

While performing the drive assist task, the CPU 11 generates, based on an image currently picked-up by the camera 22, an image to be displayed; the generated image is contained in the display region DR so that at least part of the target parking area PT is included in the image to be displayed in step S270. Then, in step S270, the CPU 11 sends the generated image to the display device 26, resulting in the image being displayed on the display device 26. After execution of the operation in step S270 is completed, the CPU 11 terminates the display control routine.

As described above, the controller 10 of the image display system 1 is configured to obtain at least one picked-up image of an imaging region IR set as a visual field in a travelling direction of the vehicle V. The controller 10 is also configured to estimate, based on the obtained at least one picked-up image, a target parking area PT of the vehicle V.

The controller 10 is further configured to

(1) Set or change, based on a position of the estimated target parking area PT relative to the vehicle V, the display mode for the obtained at least one picked-up image; the display mode represents how the at least one picked-up image is displayed on the display device 26

(2) Generate, based on the at least one picked-up image, an image to be displayed on the display device 26 according to the display mode for the at least one picked-up image such that, for example, at least part of the target parking area PT is included in the generated image to be displayed on the display device 26.

This basic configuration achieves a first advantage described hereinafter.

Specifically, this basic configuration changes the display mode for the obtained at least one picked-up image depending on change in the position of the estimated target parking area PT.

This makes it possible to generate an image to be displayed on the display device 26 such that a driver of the vehicle V can easily view the target parking area PT from the image displayed on the display device 26. That is, this basic configuration of the image display system 1 generates at least one image, which the driver of the vehicle V wants to view during parking of the vehicle V, to be displayed on the display device 26 without switching displayed images picked up by plural-view cameras. This results in the driver of the vehicle V easily parking the vehicle V in the target parking area PT with the more simplified structure of the image display apparatus 1 as compared with the structure of the system disclosed in the patent document.

Particularly, the image display system 1 includes a first specific configuration such that the display mode for the obtained at least one picked-up image is based on a sector display region DR of the obtained at least one picked-up image for the display device 26; the sector display region DR is set to horizontally expanding in the vehicle width direction and has a view angle θ1.

The first specific configuration estimates, based on the obtained at least one picked-up image, a distance between the vehicle V and the estimated target parking area PT. Then, first specific configuration

(1) Determines whether the distance between the vehicle V and the estimated target parking area PT is equal to or greater than each of the first and second threshold distances Td and Tc; the second threshold distance Tc is smaller than the first threshold distance Tc

(2) Sets the view angle θ1 of the display region DR when the distance is equal to or greater than the first threshold distance Td to be wider than the view angle θ1 when the distance is smaller than the second threshold distance Tc.

Therefore, the first specific configuration achieves a second advantage described hereinafter.

Specifically, the first specific configuration generates an image to be displayed on the display device 26 according to change of the display region DR such that

(1) The image permits the driver of the vehicle V to view a horizontally wide area as the visual field in the travelling direction of the vehicle V when the distance between the vehicle V and the estimated target parking area PT is equal to or greater than the first threshold distance Td

(2) The image permits the driver of the vehicle V to view concentratedly the target parking area PT when the distance between the vehicle V and the estimated target parking area PT is smaller than the second threshold distance Tc.

When the distance between the vehicle V and the estimated target parking area PT is equal to or greater than the first threshold distance Td, the driver of the vehicle V should have a requirement to view a horizontally wide area as the visual field in the travelling direction of the vehicle V. This is because it is necessary for the driver to visibly recognize where the target parking region PT is located and circumstances around the target parking region PT.

In contrast, when the distance between the vehicle V and the estimated target parking area PT is smaller than the second threshold distance Tc, the driver of the vehicle V should have a requirement to view concentratedly the target parking area PT in order to reliably park the vehicle V in the target parking area PT.

In view of these circumstances, the first specific configuration set forth above satisfies the requirements of the driver of the vehicle V in any of these cases where

1. The distance between the vehicle V and the estimated target parking area PT is equal to or greater than the first threshold distance Td

2. The distance between the vehicle V and the estimated target parking area PT is smaller than the second threshold distance Tc.

Additionally, the image display system 1 includes a second specific configuration that

(1) Determines whether the distance between the vehicle V and the estimated target parking area PT is equal to or greater than each of the first and second threshold distances Td and Tc

(2) Sets the dip angle θd of the imaging region IR, i.e. the display region DR, when the distance is smaller than the second threshold distance Tc to be greater than the dip angle θd when the distance is equal to or greater than the first threshold distance Td.

Therefore, the second specific configuration achieves a third advantage described hereinafter.

Specifically, the second specific configuration generates an image to be displayed on the display device 26 according to change of the display region DR such that

(1) The image having a greater value of the dip angle θd of the imaging region IR permits the driver of the vehicle V to view concentratedly the target parking area PT when the distance between the vehicle V and the estimated target parking area PT is smaller than the second threshold distance Tc.

(2) The image having a smaller value of the dip angle θd of the imaging region IR permits the driver of the vehicle V to view a horizontally wide area as the visual field in the travelling direction of the vehicle V.

That is, when the distance between the vehicle V and the estimated target parking area PT is smaller than the second threshold distance Tc, the driver of the vehicle V should have a requirement to view concentratedly the target parking area PT in order to reliably park the vehicle V in the target parking area PT.

In contrast, when the distance between the vehicle V and the estimated target parking area PT is equal to greater than the first threshold distance Td, the driver of the vehicle V should have a requirement to view a horizontally wide area as the visual field in the travelling direction of the vehicle V.

In view of these circumstances, as described above, the second specific configuration satisfies the requirements of the driver of the vehicle V in any of these cases where

1. The distance between the vehicle V and the estimated target parking area PT is equal to or greater than the first threshold distance Td

2. The distance between the vehicle V and the estimated target parking area PT is smaller than the second threshold distance Tc.

Note that the first and second threshold distances Tc and Td can be set to be equal to each other. In addition, note that the first and second threshold distances Tc and Td used for controlling the view angle θ1 of the display region DR can be respectively different from the first and second threshold distances Tc and Td used for controlling the dip angle θd of the imaging region IR, i.e. the display region DR.

The image display system 1 includes a third specific configuration to adjust the display mode for the obtained at least one picked-up image according to at least one of the travelling-condition signals and the travelling-environment signals sent from the various sensors 21 (see steps S220 and S250).

This third specific configuration makes it possible to adjust the display mode for the obtained at least one picked-up image more suitably for the current travelling conditions of the vehicle V and/or the current travelling environments around the vehicle V.

Particularly, even if it is determined that the CPU 11 has not succeeded in estimating at least one parking-area candidate (NO in step S210), this third specific configuration makes it possible to set the display mode for the obtained at least one picked-up image according to at least one of the travelling-condition signals and the travelling-environment signals sent from the various sensors 21.

The image display system 1 includes a fourth specific configuration to set or change, based on the travelling-condition signals and/or the travelling-environment signals in addition to the position of the estimated target parking area PT, the display mode for the obtained at least one picked-up image. This fourth specific configuration makes it possible to properly generate an image of a part of the at least one picked-up image, which the driver wants to view, to be displayed on the display device 26.

The image display system 1 includes a fifth specific configuration that estimates one of two or more parking-area candidates as the target parking area PT for the vehicle V according to at least one of the travelling-condition signals and the travelling-environment signals sent from the various sensors 21 if the two or more parking-area candidates exist in at least one picked-up image (see step S240). This fifth specific configuration results in a proper estimation of one of the two or more parking-area candidates as the parking area for the vehicle V.

The image display system 1 includes a sixth specific configuration that determines whether (i) the driver of the vehicle V is about to perform the backward parking of the vehicle V or performing the backward parking of the vehicle V, or (ii) the vehicle V is trying to start or is starting in a given travelling direction. This sixth specific configuration also sets the display mode for the at least one picked-up image to a predetermined mode, i.e. the first display mode, suitable for the starting of the vehicle V. This sixth specific configuration supplies an image displayed on the display device 26 to the driver more suitable for the starting of the vehicle V.

The image display system 1 includes a seventh specific configuration that

(1) Detei mine whether the second criteria time has elapsed since the vehicle V was powered on (i.e. power supply to the vehicle V was started) (see step S330)

(2) Deter mine that the driver of the vehicle V is trying to move or is moving the vehicle V backward to park the vehicle V when it is determined that the second criteria time has elapsed since the vehicle V was powered on (see step S340)

(3) Determine that the vehicle V is trying to start backward or is starting backward when it is determined that the second criteria time has not elapsed yet since the vehicle V was powered on (see step S350).

This seventh specific configuration simply determines whether (i) the driver of the vehicle V is about to perform the backward parking of the vehicle V or performing the backward parking of the vehicle V, or (ii) the vehicle V is trying to start or is starting.

The image display system 1 includes an eighth specific configuration that

(1) Changes the display mode for at least one picked-up image from the first display mode to the second display mode when a first condition is satisfied; the first condition represents, for example, that the value of the distance of the target parking area PT is lower than the second threshold distance Tc

(2) Changes the display mode for at least one picked-up image from the second display mode to the first display mode when a second condition is satisfied; the second condition represents, for example, that the value of the distance of the target parking area PT is equal to or greater than the first threshold distance Td (see FIGS. 5A and 5B).

This eighth specific configuration using the first and second conditions different from each other for changing the display mode for at least one picked-up image reduces frequent changes of the display mode.

This results in an improvement of the images displayed on the display device 26.

In step S250, the CPU 11 adjusts the display region DR according to the distance of the target parking area PT relative to the vehicle V, but the present disclosure is not limited thereto. Specifically, the CPU 11 can adjust the display region DR according to the speed of the vehicle V in addition to the distance of the target parking area PT relative to the vehicle V. For example, the CPU 11 can adjust the display region DR according to a value that is the product of the speed of the vehicle V and the distance of the target parking area PT relative to the vehicle V.

The image display system 1 according to this embodiment is configured to successively pick up images of the imaging region IR contained in the visual field of the vehicle V in the backward direction of the vehicle V. However, the present disclosure is not limited to the configuration. Specifically, the image display system 1 can be configured to successively pick up images of the imaging region IR contained in the visual field of the vehicle V in the forward direction of the vehicle V.

The image display system 1 according to this embodiment can be configured to change the display mode for a currently picked-up image between one of the first to third display modes, but the present disclosure is not limited thereto. Specifically, the image display system 1 can be configured to change the display mode for a currently picked-up image between one of the first and second display modes, or one of three or more display modes; each of the display modes is set to a corresponding view angle and a corresponding dip angle.

While the illustrative embodiment of the present disclosure has been described herein, the present disclosure is not limited to the embodiment described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. An apparatus for generating an image to be displayed on a display device, the apparatus comprising:
a memory device; and
a controller communicable to the memory device,
the controller being configured to:
obtain at least one picked-up image in a travelling direction of a vehicle;
determine whether or not a driver of the vehicle is about to perform parking of the vehicle or is performing parking of the vehicle;
estimate, based on the obtained at least one picked-up image, a target parking area of the vehicle when it is determined that the driver of the vehicle is about to perform parking of the vehicle or is performing parking of the vehicle;
set, based a position of the estimated target parking area relative to the vehicle, a display mode for the obtained at least one picked-up image, the display mode representing how the at least one picked-up image is displayed on the display device; and
generate, based on the at least one picked-up image and the display mode for the at least one picked-up image, an image to be displayed on the display device.

2. The apparatus according to claim 1, wherein:
the display mode for the obtained at least one picked-up image is based on a display region of the at least one picked-up image for the display device, the display region being set to horizontally expand in a width direction of the vehicle and having a view angle;
the controller is configured to:
estimate a distance of the target parking area relative to the vehicle; and
perform at least one of:
a first task to:
determine whether the distance of the target parking area relative to the vehicle is equal to or greater than a threshold distance for the view angle; and
set the view angle of the display region when the distance is equal to or greater than the threshold distance for the view angle to be wider than the view angle of the display region when the distance is smaller than the threshold distance for the view angle, and
a second task to:
determine whether the distance of the target parking area relative to the vehicle is equal to or greater than a threshold distance for a dip angle of the display region; and
set the dip angle of the display region when the distance is smaller than the threshold distance for the dip angle to be greater than the dip angle of the display region when the distance is equal to or greater than the threshold distance for the dip angle.

3. The apparatus according to claim 1, wherein the controller is configured to:
obtain vehicle-related information indicative of at least one of a travelling condition of the vehicle and a travelling environment around the vehicle; and
perform one of:
setting the display mode for the obtained at least one picked-up image based on the vehicle-related information when estimation of the target parking area of the vehicle has not succeeded; and
setting the display mode for the obtained at least one picked-up image based on the vehicle-related info i Illation in addition to the position of the estimated target parking area relative to the vehicle.

4. The apparatus according to claim 3, wherein:
the controller is configured to select one of two or more parking areas as the target parking area according to the vehicle-related information if the two or more parking areas exist in the at least one picked-up image.

5. The apparatus according to claim 1, wherein, when it is determined that the driver of the vehicle is neither about to perform parking of the vehicle nor is performing parking of the vehicle, but that the vehicle is trying to start or is starting, the controller is configured to set the display mode for the obtained at least one picked-up image to a predetermined mode suitable for the starting of the vehicle. 15

6. The apparatus according to claim 5, wherein the controller is configured to:
determine whether a criteria time has elapsed since the vehicle was powered on; and
determine that the driver of the vehicle is about to perform. parking of the vehicle or is performing parking of the vehicle when it is determined that the criteria time has elapsed since the vehicle was powered on; and
determine that the vehicle is trying to start or is starting when it is determined that the criteria time has not elapsed yet since the vehicle was powered on.

7. The apparatus according to claim 1, wherein the controller is configured to:
change the display mode for at least one picked-up image from a first display mode to a second display mode when a predetermined first condition between the position of the target parking area and the vehicle is satisfied; and
change the display mode for at least one picked-up image from the second display mode to the first display mode when a predetermined second condition between the position of the target parking area and the vehicle is satisfied, the second condition being different from the first condition.

8. A computer program product comprising
a non-transitory computer-readable storage medium; and
a set of computer program instructions embedded in the computer-readable storage medium, the instructions causing a computer to carry out:
a first step of obtaining at least one picked-up image in a travelling direction of a vehicle;
a second step of determining whether or not a driver of the vehicle is about to perform parking of the vehicle or is performing parking of the vehicle;
a third step of estimating, based on the obtained at least one picked-up image, a target parking area of the vehicle when it is determined that the driver of the vehicle is about to perform parking of the vehicle or is performing parking of the vehicle;
a fourth step of setting, based a position of the estimated target parking area relative to the vehicle, a display mode for the obtained at least one picked-up image, the display mode representing how the at least one picked-up image is displayed on the display device; and
a fifth step of generating, based on the at least one picked-up image and the display mode for the at least one picked-up image, an image to be displayed on the display device.

9. The computer program product according to claim 8, wherein:
the display mode for the obtained at least one picked-up image is based on a display region of the at least one picked-up image for the display device, the display region being set to horizontally expand in a width direction of the vehicle and having a view angle;
the third step is configured to estimate a distance of the target parking area relative to the vehicle; and
the fourth step is configured to perfoi in at least one of:
a first task to:
determine whether the distance of the target parking area relative to the vehicle is equal to or greater than a threshold distance for the view angle; and
set the view angle of the display region when the distance is equal to or greater than the threshold distance for the view angle to be wider than the view angle of the display region when the distance is smaller than the threshold distance for the view angle, and
a second task to:
determine whether the distance of the target parking area relative to the vehicle is equal to or greater than a threshold distance for a dip angle of the display region; and
set the dip angle of the display region when the distance is smaller than the threshold distance for the dip angle to be greater than the dip angle of the display region when the distance is equal to or greater than the threshold distance for the dip angle.

10. The computer program product according to claim 8, wherein:
the instructions cause a computer to further carry out:
a sixth step of obtaining vehicle-related information indicative of at least one of a travelling condition of the vehicle and a travelling environment around the vehicle; and
the fourth step is configured to perfoi in one of:
setting the display mode for the obtained at least one picked-up image based on the vehicle-related information when estimation of the target parking area of the vehicle has not succeeded; and
setting the display mode for the obtained at least one picked-up image based on the vehicle-related information in addition to the position of the estimated target parking area relative to the vehicle.

11. The computer program product according to claim 10, wherein:
the third step is configured to select one of two or more parking areas as the target parking area according to the vehicle-related information if the two or more parking areas exist in the at least one picked-up image.

12. The computer program product according to claim 8, wherein, when it is determined that the driver of the vehicle is neither about to perform parking of the vehicle nor is performing parking of the vehicle, but that the vehicle is trying to start or is starting, the fourth step is configured to set the display mode for the obtained at least one picked-up image to a predetermined mode suitable for the starting of the vehicle.

13. The computer program product according to claim 12, wherein:
the second step is configured to:
determine whether a criteria time has elapsed since the vehicle was powered on; and
determine that the driver of the vehicle is about to perform parking of the vehicle or is performing parking of the vehicle when it is determined that the criteria time has elapsed since the vehicle was powered on; and
determine that the vehicle is trying to start or is starting when it is determined that the criteria time has not elapsed yet since the vehicle was powered on.

14. The computer program product according claim 8, wherein:
the fourth step is configured to:
change the display mode for at least one picked-up image from a first display mode to a second display mode when a predetermined first condition between the position of the target parking area and the vehicle is satisfied; and
change the display mode for at least one picked-up image from the second display mode to the first display mode when a predetermined second condition between the position of the target parking area and the vehicle is satisfied, the second condition being different from the first condition.
